(19) United States
(12) Patent Application Publication
(10) Pub. No.: US 2006/0143988 A1
(43) Pub. Date: Jul. 6, 2006

(54) Sealing billet for bodywork seals with a partially reinforced sealing profile section

(76) Inventor: Martin Dillmann, Nalbach (DE)

Correspondence Address: FRIEDRICH KUEFFNER, 317 MADISON AVENUE, SUITE 910, NEW YORK, NY, 10017, US

(21) Appl. No.: 10/533,040

(22) PCT Filed: Oct. 4, 2003
(86) PCT No.: PCT/DE03/03293

§ 371 Date: Jan. 26, 2006

(30) Foreign Application Priority Data
Oct. 31, 2002 (DE) 202 16 759.3

(51) Int. Cl. E06B 7/22

(52) U.S. Cl. 49/498.1

(57) ABSTRACT

The invention relates to a sealing billet for bodywork seals. Said sealing billet comprises a sealing profile section which, when seen along the length thereof, is reinforced in at least one area in comparison with the remaining area and is embodied in the form of a hollow-chamber profile section. The aim of the invention is to provide a sealing billet for bodywork seals which has an associated sealing profile section which is dimensionally stable in the performance of its sealing such that, when it is arranged in areas of vehicle parts which are substantially curved, the sealing profile section can match the usual radii of curvature without losing its hollow chamber profiled shape. This is achieved by means of a sealing billet (2) which has a reinforced sealing profile section in areas which are exclusively substantially curved (d), wherein the radius of curvature of the vehicle part is lower than a radius limit at which, according to the invention, the sealing profile begins to disappear.

The present invention relates to a sealing billet for sealing between a movable vehicle part and the bodywork of a vehicle, said sealing profile is constructed as a hollow-chamber profile, wherein the sealing billet exhibits a sealing profile which is reinforced into the hollow-chamber at least in one area intended for high curvature, and wherein the reinforcement which extends in the longitudinal direction of the sealing billet prevents or limits the collapse of the sealing billet in the sealing area of the sealing profile.

Such sealing billets are used in the area of the vehicle body, between the movable vehicle parts and the bodywork, particularly between the door and side panel, between the bodywork and the tailgate or the bodywork and the front hood. They seal off the interior, for example the passenger compartment, especially from incoming moisture and noise. The sealing function must be performed reliably regardless of frequent operation of the movable vehicle part.

The sealing profile of such a sealing billet is divided into a fastening area and a sealing area. The sealing billet is attached for example to the vehicle part by way of the fastening area. This can be effected by mounting on a flange arranged on the vehicle part or by gluing. The fastening area of the sealing billet must be designed accordingly.

The sealing area performs the actual sealing function. It is often formed by a tubular hollow-chamber profile. In doing so, the area of the hollow-chamber wall which is located closest to the fastening surface can also be formed by the fastening area, so that the sealing area and the fastening area merge in this case.

A harder, rubber like material is mostly used for the fastening area rather than for the sealing area which is often made of a soft or micro-cellular rubber. The soft rubber is more easily moldable and adapts better to the geometry of the gap cavity to be sealed than a harder rubber-like material. This material is conducive to a good sealing action.

The requirements for the sealing area can be described as follows:—to perform the sealing function between vehicle body and movable vehicle part even after frequent operation of the vehicle part,—marginal clamping forces between the vehicle body and the movable vehicle part,—light weight,—low production costs.

The sealing function is achieved when the sealing billet securely fills the gap between the vehicle body and the movable vehicle part in a closed state at each point along the outside circumference of the vehicle part, so that for example moisture cannot enter the passenger compartment.

The sealing billet must enable a marginal clamping force between the vehicle body and the movable vehicle part. When closing the movable vehicle part must engage the locking mechanism on the vehicle body with the least exertion possible, however the fit between both parts must be close enough in a closed state that the above-mentioned sealing function is achieved.

In order to save both material in the production of the automobile and fuel in the operation thereof, the weight of the sealing billet should be kept as light as possible.

The production costs should be kept as low as possible especially provided that such~a sealing billet is a mass-produced product.

A sealing billet for bodywork seals is generally extruded from a rubber-like material and then normally cut to length by the seal manufacturer corresponding for example to the outside circumference of the vehicle part. At the automobile manufacturer the seal is either mounted on a slip-on flange for example belonging to a movable vehicle part or glued onto a fastening surface. The slip-on flange nor the fastening surface do not always proceed straight in this regard. The sealing billet must also be mounted in areas with a high degree of curvature, for example in the upper door window cutout. Without countermeasures however the hollow-chamber profile will collapse in areas of such tight curvature when falling short of a certain critical radius. This can be explained by the fact that the path of the sealing billet in the interior of the curvature close to the fastening surface is shorter than in the opposing area of the hollow-chamber profile, i.e., in the exterior of the curvature.

As a result tensions arise in the cross section of the sealing billet which allow the wall of the hollow-chamber profile located at the exterior of the curvature to collapse toward the center of the sealing profile. If this circumstance arises the sealing billet will not longer be able to reliably perform its sealing function in the areas of high curvature since the gap between the vehicle body and the movable vehicle part is no longer completely filled. The clamping force will also be increased and the movable vehicle part will possibly no longer engage the locking mechanism.

The collapse of the hollow-chamber profile wall is amplified by the fact that the wall is made of soft rubber as described above. This is advantageous for the sealing function but it negatively influences the dimensional stability of the hollow-chamber profile.

Known measures to prevent the collapse of the sealing area include:—Reinforcing or supporting the wall of the hollow-chamber profile. This can be effected by inserting a stabilizing element such as, for example a second tube, or by filling a stabilizing mass, for example polyurethane foam, into the hollow-chamber. This requires, however, an additional process and additional material consumption for the making of the sealing billet, which increases the costs-and time of production. In addition, such measures increase the clamping forces which must be applied in order to lock the movable vehicle part with the vehicle body. These measures also effect an increase in the weight of the sealing billet.

Bending the sealing billet into the desired form. In this case, the section of the sealing billet which is to be mounted in an area of high curvature is fitted in a form under heat to the contour of the curved area for the vehicle part. The heating provides that the sealing billet retains its desired curved shape even after subsequent cooling. This second process also leads to an increase in production costs, aggravated by the energy costs associated herewith. In addition, such a permanent bending leads to at least a two-dimensional design of the sealing billet which complicates transport from the sealing manufacturer to the sealing billet mounting site at the automobile manufacturer, due to the fact that the sealing billet-requires more space to be transported than an unbent sealing billet.

DE 100 05 642 A1 describes a border gap sealing for sealing a top cover vis-a-vis the vehicle roof. A build-up of the sealing shoulder which arises especially in a tilted top cover position is prevented by means of a thickening of the material (reference number 18), which extends into the hollow chamber, particularly also in interaction with deliberate kinks. The material thickening is arranged in the area of the cross section, preferably in the upper third thereof and extends the entire length of the sealing shoulder. The reinforcement of the hollow-chamber profile across the entire length of the sealing shoulder however leads to excessive material requirements which in turn increases not only material inputs in production and production costs as a result, but also the weight of the seal.

EP 0 586 073 A1 describes extrusion billets exhibiting a hollow-chamber profile and with reinforcements which extend into the hollow chamber in the areas of curvature. The reinforcements are created by modifications of the extrusion gap cross section, wherein the hollow-chamber profile is either comprised of two simultaneously extruded billets or produced ex- post by means of reshaping of a single extruded billet.

A seal of the afore-mentioned type is described in U.S. Pat. No. 4,448,430. A nonattached web along the longitudinal ridge serves as a reinforcement extending into the hollow chamber which is fitted in the sealing profile through a small hole in the wall of the sealing profile and glued to the sealing profile.

Based on this, the invention has the objective to further develop a sealing billet of the afore-mentioned type which exhibits at least an equal dimensional stability in the areas of curvature but can be manufactured at very little expense.

The sealing billet which meets these requirements according to the present invention is characterized in that the reinforcement is molded as one piece in a continuous extrusion process by modifying the gap cross section of the extrusion gap which forms the hollow-chamber profile in its entirety.

According to the invention the production of the entire sealing billet is carried out by means of variable extrusion, wherein the extrusion gap of the extruder is displacement-controlled during continuous extrusion and varies depending on the length of the specified areas, whereby the molded reinforcement extends into the hollow-chamber which is extruded in its entirety. Due to the fact that the sealing profile is reinforced in clearly defined areas where there is a danger that the hollow-chamber profile will collapse, sealing material is economized which consequently minimizes the production costs and weight of the sealing billet. Additionally, the clamping force is kept marginally low as a result.

The advantageous embodiments of the reinforced sealing profile are designed such that they can be extruded in one process. A second process such as, for example the insertion of a second tube or bending, is omitted. Low production costs are the result. In this regard the position of the reinforcements are chosen such that they extend into the hollow chamber, so that the areas of the sealing billet with a reinforced sealing profile do not externally differ from the other areas.

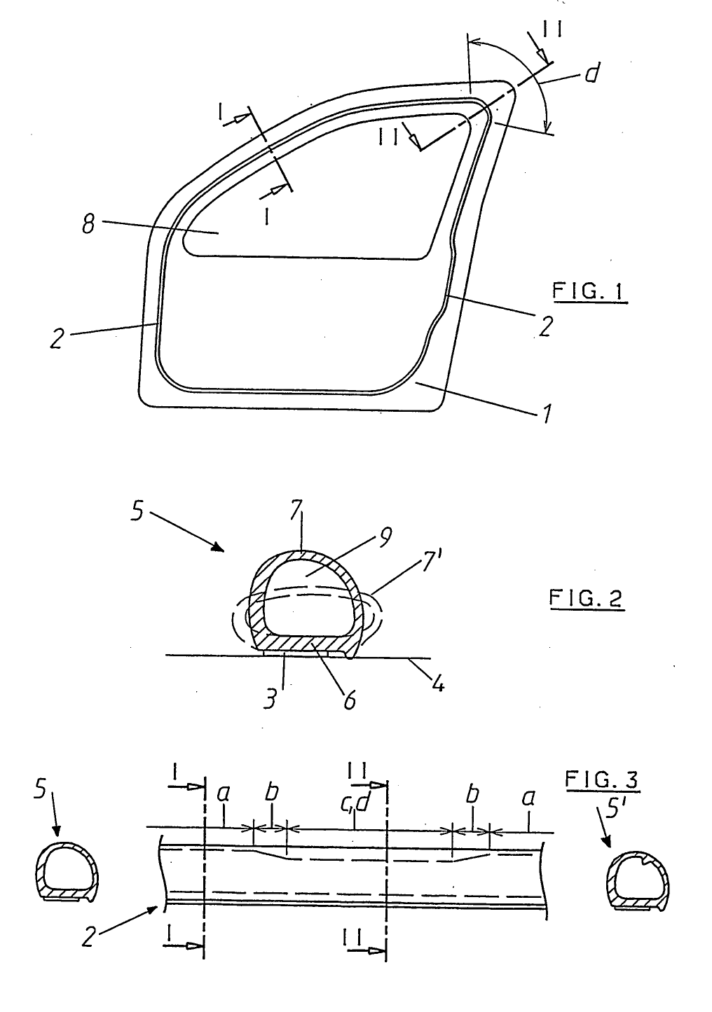

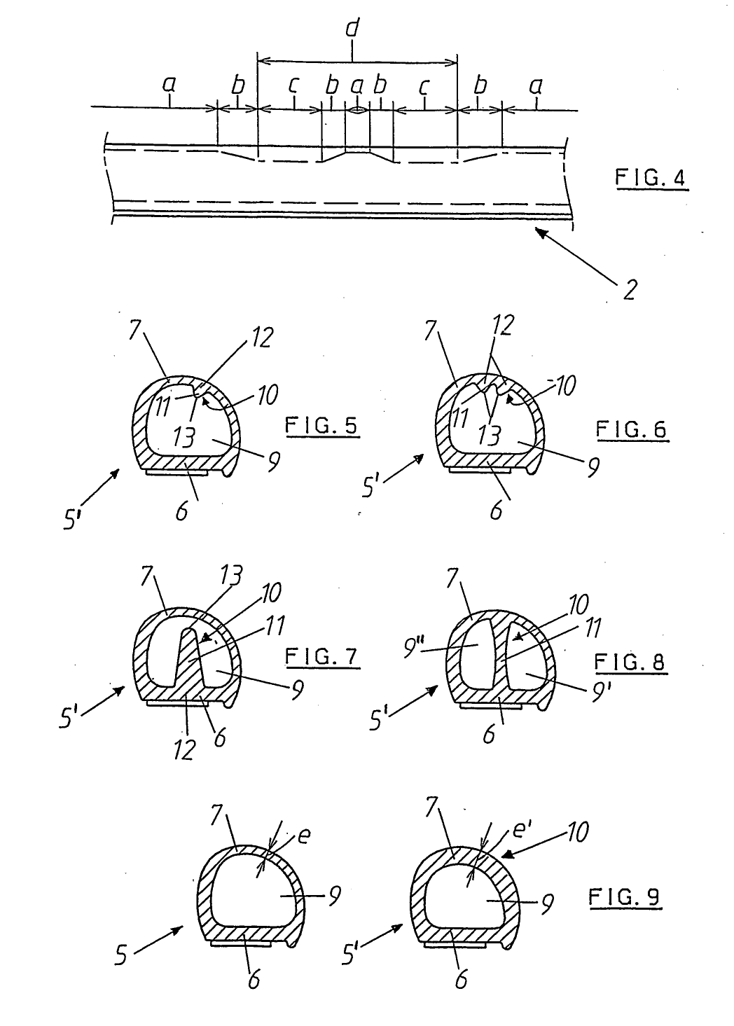

The invention is illustrated in FIGS. 1 to 9 based on a sample design of a sealing billet which is mounted on a movable vehicle part, in this case glued on a car door, and is described herein with reference to the drawings, wherein: FIG. 1 is a top view of a car door as seen from the passenger compartment. FIG. 2 is an unreinforced sealing profile in a normal state and in a collapsed state (shown with a dashed line). FIG. 3 shows an unreinforced sealing profile in the area of line I-I, a scaleless longitudinal section through a sealing billet with continuous reinforcement throughout the entire area of high curvature and a reinforced sealing profile in the area of line-II-II. FIG. 4 shows a scaleless longitudinal section through a sealing billet with a broken reinforcement in the area of high curvature. FIGS. 5 to 9 show advantageous embodiments of reinforced sealing profiles.

FIG. 1 shows a top view of a car door 1 as seen from the passenger compartment. As seen in connection with FIG. 2, the sealing billet 2 was attached by means of adhesive system 3—this can be, for example an adhesive or adhesive tape applied to the car door or the sealing billet—to a fastening surface 4 of the car door. The unreinforced sealing profile shown in FIG. 2 is divided into a fastening area 6 and a sealing area 7. The sealing area is designed as a hollow-chamber profile. The sealing area and the fastening area are in this example made of the same material; however it is customary to construct the sealing area using a softer material, for example, micro-cellular rubber compared to the fastening area.

The length of the sealing billet is measured such that it forms a closed ring when mounted on the car door. The sealing billet follows the curvature of the car door at multiple points. The radii of the curvatures vary. In the area of high curvature d at the upper corner of the window cutout 8 the sealing billet has to follow at such a small curvature radius that the wall of the sealing area 7 opposite the fastening area 6 would collapse toward the center of the sealing profile into the hollow chamber 9. The position of the collapsed wall of the unreinforced sealing area 7′ is shown with a dashed line in FIG. 2. In the extreme case a deformation takes place until the wall of the hollow-chamber profile opposite the fastening area abuts the fastening area. In this state, the sealing profile does not completely fill the cavity between the car door and the vehicle body. Thus, the sealing function cannot be performed satisfactorily in this area of curvature.

FIG. 3 shows to the left an unreinforced sealing profile 5 corresponding to. FIG. 2 in the area of line i-i, in the middle part a longitudinal section through a sealing billet 2 which scalelessly extends through lines i-i and II-II as well as a reinforced sealing profile 5′ as designed in the area of line II-II. The longitudinal section is made of three segments:—the sealing profile is unreinforced in segment a,—the sealing profile is reinforced in segment c,—segment b is the transition area between segments a and b. In this section, the gap of the extrusion tool is converted under continuous extraction from the cross section of an unreinforced sealing profile 5 to a cross section of a reinforced sealing profile 5′ during the production of the sealing billet.

In the area of high curvature d the reinforcement of the sealing profile can exhibit a continuous design as shown in FIG. 3 or a broken design corresponding to FIG. 4. The broken design increases the flexibility of the sealing billet and leads to less material usage. In FIG. 4 the area of high curvature d is therefore comprised of several segments with an unreinforced sealing profile a and multiple segments with a reinforced sealing profile c as well as many transitions b. The length of the sections a within the area of high curvature d should be chosen such that the sealing profile does not collapse.

A reinforced sealing profile 5′ is shown on the right side of FIG. 3. FIG. 5 shows the same sealing profile on a larger scale. Further advantageous embodiments of the reinforced sealing profile 5′ are shown on a larger scale in FIGS. 6 to 9. The reinforcements 10 are designed such that no difference can be distinguished from outside between the segments a with an unreinforced sealing profile and segments c with a reinforced sealing profile.

In FIGS. 5 to 8 the reinforcements 10 are designed as webs 11. In FIGS. 5 and 6 the webs are short and wedge-shaped. The web roots 12 are located in the wall of the sealing area 7 opposite the fastening area 6.

The web tips 13 extend into the hollow-chamber and point to the fastening area. The reinforcement 10 may be comprised of one web, as shown in FIG. 5, or of several webs 11 as shown in FIG. 6.

FIG. 7 also shows the reinforcement 10 as a wedge-shaped web 11; however its proportions are larger than those of webs in FIGS. 5 and 6 and it projects beyond the center of the sealing profile. The collapsing hollow-chamber profile should set itself down on the tip of the web and subsequently not be further deformed. The collapse of the sealing area is thereby not prevented but rather limited. The web root 12 is located in the fastening area 6, the web tip 13 points to the wall of the hollow-chamber profile opposite the fastening area 6. In a further embodiment, it is possible to arrange several of these webs in the hollow-chamber profile.

In FIG. 8 the reinforcement 10 of the sealing profile 5′ is designed as a web 11 which divides the hollow-chamber into two hollow-chamber partitions 9′ and 9″. Contrary to the webs described heretofore, this web extends continuously between the fastening area 6 and the opposing wall of the sealing area. It is also possible in this case to arrange several such webs in the hollow-chamber profile, so that multiple hollow chambers are created.

A sealing profile 5 without reinforcement is shown on the left side of FIG. 9. The wall of the sealing area 7 has a wall thickness e. A reinforced sealing profile 5′ is juxtaposed on the right side of FIG. 9. The reinforcement 10 in this case is based on the enlargement of the wall thickness e′ in the region of the sealing area.

List of Reference Numbers

| | |
|---|---|
| 1 | Car door |
| 2 | Sealing billet |
| 3 | Adhesive system |
| 4 | Fastening surface |
| 5/5′ | Sealing profile (unreinforced/reinforced) |
| 6 | Fastening area |
| 7 | Sealing area (dimensionally stabile/collapsed) |
| 8 | Window cutout |
| 9 | Hollow-chamber |
| 9′/9″ | Hollow-chamber partitions |
| 10 | Reinforcement |
| 11 | Web |
| 12 | Web root |
| 13 | Web tip |
| a | Segment of a sealing billet with unreinforced sealing |
| | profile |
| b | Transition |
| c | Segment of a sealing billet with reinforced sealing |
| | profile |
| d | Area of high curvature |
| e/e′ | Wall thickness of the hollow-chamber profile in the |
| | sealing area (unreinforced/reinforced sealing profile) |

1. A sealing billet for sealing between a movable vehicle part and the bodywork of an automobile, said sealing profile is constructed as a hollow-chamber profile, wherein the sealing billet exhibits a sealing profile which is reinforced into the hollow-chamber in at least one area intended for high curvature, and wherein the reinforcement which extends in the longitudinal direction of the sealing billet prevents or limits a collapse of the sealing area of the sealing profile, wherein the reinforcement is molded as one piece in a continuous extrusion process by modifying the gap cross section of the extrusion gap which forms the hollow-chamber profile in its entirety.

2. The sealing billet according to claim 1, wherein segments with a reinforced sealing profile are separated by at least one segment with an unreinforced sealing profile within an area of high curvature.

3. The sealing billet according to claim 1, wherein the reinforcement is constructed as at least one web.

4. The sealing billet according to claim 1, wherein the at least one web is wedged-shaped and does not extend beyond the center of the sealing profile, that the at least one web root is located in the wall of the sealing area opposite the fastening area, and that the at least one web tip extends into the hollow-chamber and points in the direction of the fastening area.

5. The sealing billet according to claim 1, wherein the at least one web is wedge-shaped and extends beyond the center of the sealing profile, that the at least one web root is located in the fastening area, and that the at least one web tip extends into the hollow-chamber and points in the direction of the wall of the sealing area opposite the fastening area.

6. The sealing billet according to claim 1, wherein the at least one web extends continuously between the fastening area and the wall of the sealing area opposite the fastening area and divides the hollow-chamber into at least two hollow-chamber partitions.

7. The sealing billet according to claim 1, wherein the reinforcements are designed as enlargements to the wall thickness of the sealing area for a reinforced sealing profile compared to the wall thickness of the sealing area for an unreinforced sealing profile.
